(19) United States
(12) Patent Application Publication
(10) Pub. No.: US 2010/0221512 A1
(43) Pub. Date: Sep. 2, 2010

(54) DIGITAL METAMORPHIC ALLOYS FOR GRADED BUFFERS

(75) Inventors: Kenneth E. Lee, Singapore (SG); Eugene A. Fitzgerald, Windham, NH (US)

Correspondence Address: WOLF GREENFIELD & SACKS, P.C., 600 ATLANTIC AVENUE, BOSTON, MA, 02210-2206, US

(73) Assignee: Massachusctts Institute of Technology, Cambridge, MA (US)

(21) Appl. No.: 12/395,564

(22) Filed: Feb. 27, 2009

(51) Int. Cl. B32B 7/02; B05D 1/36

(52) U.S. Cl. 428/213; 427/402

(57) ABSTRACT

Digital metamorphic alloy (DMA) buffer structures for transitioning from a bottom crystalline layer to a lattice mismatched top crystalline layer, and methods for manufacturing such layers are described. In some embodiments, a layered crystalline structure includes a first layer of a first crystalline material having a first in-plane lattice constant and a second layer of a second crystalline material disposed over the first layer and having a second in-plane lattice constant that is lattice mismatched with the first crystalline material. Multiple sets of buffer layers may be disposed between the first layer and the second layer. Each set is a digital metamorphic alloy including a buffer layer of a third crystalline material and a buffer layer of a fourth crystalline material where an effective in-plane lattice constant of each set falls between the first lattice of the first layer and the second lattice constant of the second layer.

### BACKGROUND

1. Technical Field

The invention relates to a layered crystalline structure having first and second layers with different in-plane lattice constants and sets of buffer layers disposed between the first and second layers for transitioning between the in-plane lattice constant of the first layer and the in-plane lattice constant of the second material, and to a method of making such a material structure.

2. Discussion of Related Art

The integration of lattice-mismatched layers on conventional substrates enables the fabrication of numerous electronic and optoelectronic devices on standard substrates. An obstacle in the integration of such materials onto conventional substrates, such as bulk silicon (Si) or bulk gallium arsenide (GaAs), is the lattice mismatch between the deposited layers and the underlying substrate. When an in-plane lattice constant of a layer differs from an in-plane lattice constant of the substrate or of another thick underlying layer, this condition is described as lattice mismatch. When depositing a layer that is lattice mismatched, defects may be created in the deposited lattice mismatched layer, which accommodate the lattice mismatch and thereby reduce an overall energy state of the underlying layer and the substrate. Examples of such defects include misfit dislocation segments that extend along the interface of the deposited lattice-mismatched layer and the substrate, and threading dislocation segments, which connect to the ends of the misfit segments and terminate at the surface of the lattice-mismatched layer. The presence of these threading dislocations in device layers may degrade device performance and complicate processing; thus, the minimization of threading dislocation densities in lattice-mismatched layers is of importance in the fabrication of electronic and optoelectronic devices.

A number of techniques have been employed to reduce threading dislocation densities in lattice-mismatched layers. A common technique includes the deposition of an alloy graded layer on the substrate, wherein the content of the alloy is gradually varied with deposition thickness so as to suppress the nucleation of large numbers of threading dislocations. The transition layers that allow a transition from a first, bottom layer, such as the substrate or a thick underlying layer, having a first in-plane lattice constant to a second, top layer having a mismatched in-plane lattice constant with reduced threading dislocation density in the top layer are often described as alloy buffer layers. For example, in the case of silicon-germanium on silicon substrates, a silicon-germanium graded buffer layer may be deposited on the substrate, wherein the germanium content of the silicon-germanium alloy is gradually increased up to a final germanium content desired for the application. The end result is a relaxed (i.e., unstrained) alloy graded buffer layer, possessing an equilibrium lattice constant differing from the substrate lattice constant, wherein the threading dislocation density at the surface of the graded buffer layer is several orders of magnitude lower than if a uniform composition alloy layer, possessing the final alloy composition, had been directly deposited onto the substrate. The surface of the top layer having the final alloy composition may be described as a virtual substrate of the final alloy composition.

When transitioning between a substrate, or other thick underlying layer, comprising a binary crystalline material and an upper layer comprising a lattice mismatched layer of a binary crystalline material including an element different than those present in the substrate alloy, compositionally graded buffer layers may include complex alloys, such as ternary or quaternary alloys, that introduce further complications and difficulties. As one example, compositionally-graded metamorphic buffers using InₓGa₁₋ₓAs, a ternary alloy system, have been used to obtain virtual substrates with lattice constants intermediate to GaAs and InP. However, these complex alloy graded buffers have several limitations that might restrict their usefulness for device applications. First, the propensity of the InₓGa₁₋ₓAs alloy to phase separate at mole fractions greater than ˜0.35 means that it may not be possible to obtain high-quality, low threading dislocation density (TDD) graded buffers at compositions with x>0.35 using conventional compositionally-graded metamorphic buffer layers. This limits the virtual substrate lattice-constant of the top layer InGaAs alloy produced using conventional compositionally-graded metamorphic layers to about 5.795 Å. Second, the thermal conductivities of the ternary InGaAs alloys are known to be poor, which may be a significant problem for device applications requiring high power and/or high heat densities.

### SUMMARY

Such limitations are addressed by some embodiments of the present invention. A first aspect discussed below is a layered crystalline structure having a first layer of a first crystalline material, a second layer of a second crystalline material that overlays the first layer and that is lattice mismatched with the first layer, and a digital metamorphic alloy (DMA) graded buffer structure for transitioning from the first layer to the lattice mismatched second layer. The DMA graded buffer structure includes multiple sets of buffer layers, with each set including a constituent buffer layer of a third crystalline material and a constituent buffer layer of a fourth crystalline material. Each set may be described as a DMA. An effective lattice constant of each set falls between a first lattice constant of the first layer and a second lattice constant of the second layer. A ratio of a thickness of the buffer layer of the third crystalline material to a thickness of the buffer layer of the fourth crystalline material for each set decreases with an increasing separation between the first layer and the set.

In some embodiments, the thicknesses of each buffer layer in each set may be less than a critical thickness for threading dislocation formation for the buffer layer. The buffer layers may be epitaxial with the first layer and the second layer may be epitaxial with the buffer layers. A misfit strain in each set of buffer layers may be at least about 70% relaxed.

In some embodiments, the first crystalline material and the third crystalline material may be a same material, and/or the second crystalline material and the fourth crystalline material may be a same material. The buffer layers may include only elemental materials and/or binary materials. The first crystalline material and/or the second crystalline material may be a semiconductor. The mismatch between the in-plane lattice constant of the first layer and the in-plane lattice constant of the second layer may be at least about 0.3%.

In some embodiments the first layer includes a substrate, and in other embodiments the first layer overlies a substrate. A set of buffer layers, may include multiple buffer layers of the third crystalline material and/or multiple buffer layers of the fourth crystalline material. A threading dislocation density in the second layer may be less than about 10⁸ dislocations per cm².

Another aspect relatives to a method of manufacturing a layered crystalline structure that includes providing a first layer of a first crystalline material, depositing multiple of sets of buffer layers over the first layer, and depositing a second layer of crystalline material that is lattice mismatched with the first layer over the multiple sets of buffer layers. Depositing a set of buffer layers includes depositing a buffer layer of a third crystalline material having a first thickness, and depositing a buffer layer of a fourth crystalline material having a second thickness, where a ratio of the first thickness to the second thickness decreases with increasing separation between the first layer and the set for each set.

In some embodiments, the method also includes pausing deposition between deposition of a buffer layer of the first crystalline material and deposition of a buffer layer of the second crystalline material. The method may further include annealing the first layer and at least one set of buffer layers after deposition of the at least one set. The first layer and the at least one set of buffer layers may be annealed until at least 70% of the misfit strain is relaxed in the at least one set of buffer layers. The method may further include depositing a compositionally graded buffer structure before deposition of the second layer. Each interface between a buffer layer of the third crystalline material and a buffer layer of the fourth crystalline material may include at most 5 atomic layers of intermixing.

Further inventive aspects of the invention include at least all combinations of claim limitations set forth in the appended claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a multilayer crystalline structure having sets of digital metamorphic alloy (DMA) buffer layers, in accordance with some aspects of the present invention;

FIG. 2A is a schematic diagram of a layered crystalline structure with DMA buffer layers separating a lattice mismatched InP layer and a GaAs substrate;

FIG. 2B is a schematic diagram of a layered crystalline structure having conventional compositionally-graded alloy buffer layers for comparison;

FIG. 3 is a flow chart illustrating a method for making a multilayer crystalline structure;

FIG. 4 is a cross-sectional transmission electron microscope (X-TEM) image of a DMA grown at 450° C. and a reactor pressure of 100 Torr that exhibits significant interlayer mixing;

FIG. 5 is a schematic diagram showing different gas switching sequences during deposition of constituent buffer layers for DMA buffer structures;

FIG. 6 is a graph of averaged measured growth rate versus percentage of InP on which a buffer layer is grown;

FIG. 7 is an X-TEM image of a DMA structure with constituent buffer layers having thickness larger than critical limits;

FIG. 8 is an X-TEM image of a DMA graded buffer having InP and GaP constituent buffer layers;

FIG. 9 is an X-TEM image of a buffer structure DMAGB1 with three different DMAs, grown to a terminal composition of approximately 30% InP, in accordance with some aspects of the invention;

FIG. 10 is an X-TEM image of a buffer structure DMAGB2 graded up to 60% InP and capped with InGaAs;

FIG. 11A is an X-TEM image of a buffer structure DMAGB3 before annealing;

FIG. 11B is an X-TEM image of the buffer structure after annealing;

FIG. 12 is an X-ray diffraction (XRD) reciprocal space map of the (400) family of planes for DMAGB4, a hybrid InGaAs random-alloy graded buffer and DMA graded buffer; and

FIG. 13 is an X-TEM image of DMAGB4.

### DETAILED DESCRIPTION

In light of the observations provided above, a need or desire has been recognized for a buffer layer arrangement with superior thermal conductivities. We have discovered that thin layers of constituent crystalline materials may be combined such that each set of thin layers acts in a mechanically-similar fashion to a random alloy layer, with improved characteristics. In particular, we have further appreciated that the sets of thin layers of constituent crystalline materials (which may have other uses, also) may be used as buffer layers to transition from a underlying layer (such as a substrate or other thick underlying layer) having a first lattice constant to an overlying layer having a substantially mismatched lattice constant. We term a set of multiple thin layers of constituent crystalline material materials a Digital Metamorphic Alloy (DMA). DMA buffer layers may have superior thermal conductivities to, and avoid materials growth-related problems associated with, conventional compositionally-graded random-alloy metamorphic buffers layers.

Example embodiments described herein provide layered crystalline structures that have digital metamorphic buffer layers disposed between a first layer of a first crystalline material and an a overlying second layer of a second crystalline material that is substantially lattice mismatched with the first crystalline layer. Some embodiments and aspects also include a method of making layered crystalline structures that have digital metamorphic buffer layers.

Short-period superlattices (SLs), which are structures composed of periodically alternating crystalline layers of multiple materials, have been used in the past to enhance the mechanical, electronic and optical characteristics of materials and devices in unstrained or strain-compensated structures. For example, the InAs/GaSb SL system has been used for mid-IR devices, the GaN/AlGaN material system has been used for buffers in nitride-based devices, and the GaAsP material system has been used for buffers for heterovalent integration of Si and III-V materials. The GaAs/Al(Ga)As and Si/SiGe/Ge systems, among many others, have also been used for digital alloys. However, in the past, digital alloys were generally used on either unstrained or strain-compensated structures, where the SL structures were tailored to a specific substrate or lattice-constant, and the constituent layers of the SLs were chosen such that the signs and magnitudes of their respective strains cancel out when averaged over the entire SL structure. Strain cancellation was employed to prevent the amount of strain being built up from reaching a critical amount, thereby avoiding plastic deformation of the SL layers and the generation of extended defects such as dislocations. Other past applications of digital alloys include creating electronic or optoelectronic equivalents of a mixed alloy species.

By contrast, digital metamorphic alloys (DMAs) as described herein may approximate relevant mechanical properties of crystalline materials with lattice-constants that fall between lattice-constants of the crystalline layers that constitute the digital alloys. Instead of growing a fully strain-balanced structure with a fixed equilibrium lattice-constant, as has been done in the past, multiple digital alloys may be combined, each with a slightly different lattice-constant, as buffer layers, comprising a DMA structure. In this way, the digital alloys may replace—i.e., avoid use of—complex alloys, such as ternary or quaternary alloys, in a graded buffer. This may provide the functionality of conventional complex alloy graded buffer layers without the phase separation issues and reduced thermal conductivity that are usually associated with such conventional graded buffer layers incorporating complex alloys.

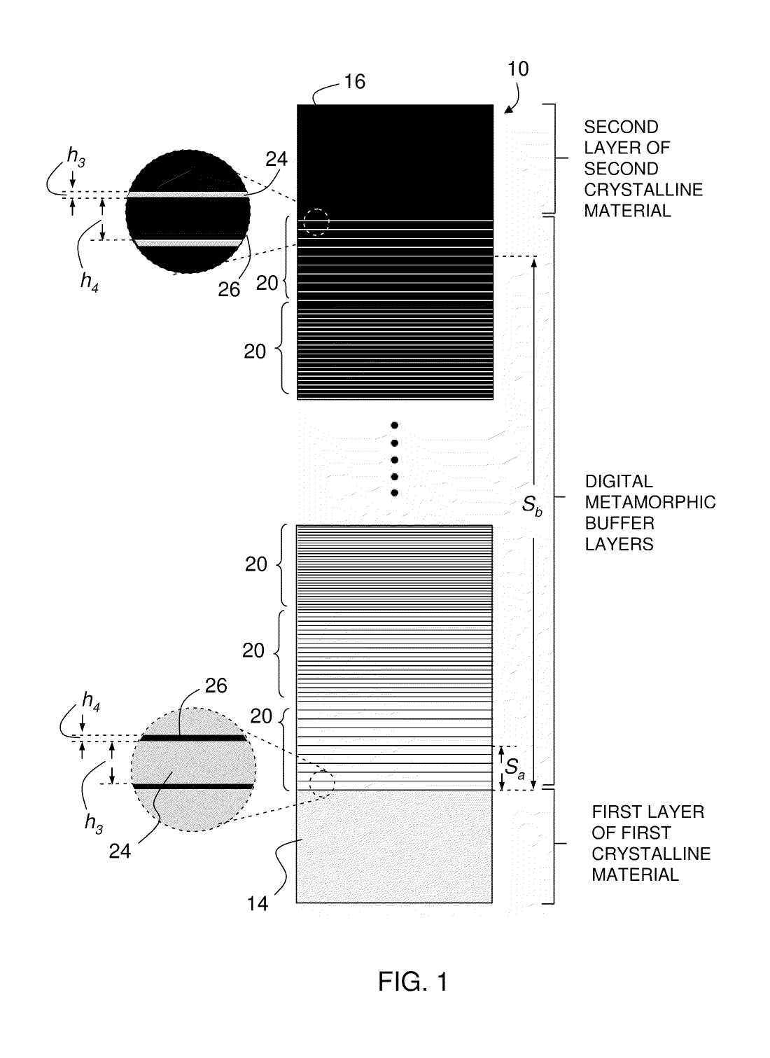

FIG. 1 schematically depicts a layered crystalline structure having a digital metamorphic alloy buffer structure, in accordance with a first possible embodiment of the invention. Note that thicknesses of constituent layers forming the buffer structure are greatly exaggerated for illustrative purposes throughout the figures. The layered crystalline structure 10 includes a first layer 14 comprising a first crystalline material having a first in-plane lattice constant a₁, and a second layer 16 disposed over the first layer and comprising a second crystalline material having a second in-plane lattice constant a₂ that is mismatched with the first in-plane lattice constant. The layered crystalline structure 10 also includes a digital metamorphic alloy buffer structure comprising multiple sets of constituent buffer layers 20 disposed between the first layer 14 and the second layer 16. In some embodiments, the first layer 14 may be the substrate, as shown, or the first layer 14 may be a layer overlying the substrate.

Each set of constituent buffer layers 20 comprises a digital metamorphic alloy including a buffer layer of a third crystalline material 24 and a buffer layer of a fourth crystalline material 26. (The terms “third” and “fourth” are used for identification purposes here, not to imply a differentiation of material content, which topic is addressed below.) A ratio of the thickness h₃ of the buffer layer comprising the third crystalline material to a thickness h₄ of the buffer layer comprising the fourth crystalline material for each set 20 preferably decreases with an increasing separation S between the first layer 12 and the set. As shown in FIG. 1, the thickness ratio is lower for the set closest to the second layer 16 that is a large distance S_{b} from the first layer 14, and the ratio is higher for the set closest to the first layer 14 that has a small separation Sₐ from the first layer 14. When the thickness ratio is higher, an effective in-plane lattice constant of the set is closer to the lattice constant of the first layer and when the thickness ratio is lower, the effective in-plane lattice constant of the set is closer to the lattice constant of the second layer. To maintain a low threading dislocation density (TDD) in the second layer 14, the thickness h₃, h₄ of each constituent buffer layer 24, 26 in each set 20 should be less than a critical thickness for threading dislocation formation in the buffer layer.

Each set of buffer layers (i.e., each DMA) may include multiple buffer layers of the third crystalline material 24, each having approximately the same thickness h₃; and multiple buffer layers 26 of the fourth crystalline material, each having approximately the same thickness h₄. This may be described as a set of buffer layers with a number of repeating periods. With this structure, a total thickness t₃ of buffer layers of the third crystalline material in a set equals the thickness h₃ of each buffer layer of the third crystalline material multiplied by the number of repeating periods in the set. Similarly, a total thickness t₄ of layers of the fourth crystalline material in a set equals the thickness h₄ of each layer of the fourth material multiplied by the number of periods in the set. In other embodiments, each set of buffer layers may only have one layer of the third crystalline material and one layer of the fourth crystalline material, but this may require a larger number of sets of buffer layers in the layered structure. This structure may be described as a DMA buffer structure with a continuously graded lattice constant, in contrast to structures that have “steps” in the grading of the lattice constants.

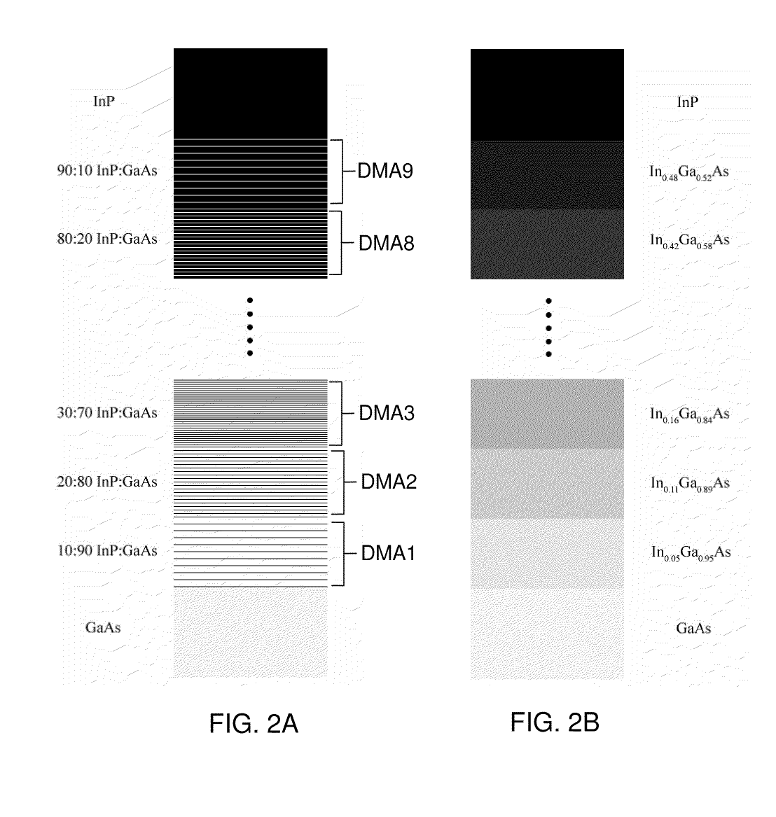

FIG. 2A schematically depicts an example of a layered crystalline structure including a Gallium Arsenide (GaAs) substrate with an Indium Phosphate (InP) layer and a DMA buffer structure that transitions from the in-plane lattice constants of the GaAs layer to the in-plane lattice constants of the overlying InP layer. For comparison, FIG. 2B schematically depicts a conventional compositionally step-graded buffer of ternary alloys. In the conventional layered crystalline structure of FIG. 2B, a series of ternary InGaAs alloys with increasing mole fraction are grown successively. This leads to a gradual change in the lattice-constant from GaAs to InP, which is lattice-matched to In_{0.53}Ga_{0.47}As. In contrast, FIG. 2A shows a layered crystalline structure that uses DMA buffer structure comprising a series of digital alloys—i.e., sets of constituent buffer layers, with different effective lattice-constants—for transitioning from a GaAs substrate to a lattice mismatched InP overlayer. Although depositing, or growing, the sets of buffer layers leads to the build-up of strain due to lattice mismatch, the buffer layers may be deposited such that each set of buffer layers behaves in a mechanically-similar fashion to a random-alloy layer and may undergo strain relaxation. Accordingly, we have named the sets of buffer layers digital metamorphic alloys (DMAs).

By using binary III-V compounds as the constituent layers in the DMAs, a metamorphic graded buffer may include exclusively binary semiconductor materials, in contrast with conventional III-V graded buffers, which, because they are compound semiconductors, necessitate the use of ternary alloys or quaternary alloys. As noted above, such ternary and quaternary alloys often have relatively low thermal conductivity. Thus, DMA buffer structures, by avoiding use of such materials, may not have many of the disadvantages associated with the use of ternary and quaternary alloys in buffer layers. For example, elemental (e.g., Si, Ge) and binary compound (e.g., GaAs, InP) semiconductors have the highest thermal conductivities of all semiconductors, while ternary and quaternary alloy semiconductors have significantly lower thermal conductivities, especially for alloy compositions far from their binary endpoints. This is demonstrated by the thermal conductivities of selected semiconductor materials, which appear in Table 1 and were taken from an archive of materials parameters available at http://www.ioffe.rssi.ru/SVA/NSM/Semicond/ as of Feb. 27, 2009.

TABLE 1

| Semiconductor | Type | Thermal conductivity (Wm⁻¹K⁻¹) |
|---|---|---|
| Si | Elemental | 130 |
| Ge | Elemental | 58 |
| GaAs | Binary | 55 |
| InP | Binary | 68 |
| In_{0.53}Ga_{0.47}As | Ternary | 5 |
| In_{0.67}Ga_{0.33}As_{0.72}P_{0.28} | Quaternary | 4 |

For metamorphic device applications, an all-binary DMA graded buffer structure may potentially provide better thermal performance, in terms of conducting heat away from the device regions, than a conventional graded buffer layer including ternary or quaternary alloys. This may be especially important in high current/power density active devices, such as lasers, amplifiers and high-power transistors. Although an all-binary DMA graded buffer layer may include more interfaces than a conventional graded buffer layer that includes ternary or quaternary alloys, the interfaces are replacing volumetric amounts of material with much lower thermal conductivity. Thus, an all-binary DMA graded buffer structure may exhibit more interfacial phonon scattering, but less bulk volume alloy phonon scattering than a conventional graded buffer structure that includes complex alloys. Ideally, an all-binary DMA graded buffer structure would have a thermal conductivity approaching a weighted average of the bulk thermal conductivities of the constituent binary buffer layer materials. However, the thermal conductivity of the DMA graded buffer structure is reduced by interfacial phonon scattering. Despite the reduction in thermal conductivity due to multiple interfaces, thermal conductivities of DMA graded buffer structures may be many times larger than those of corresponding ternary alloys used for conventional graded buffer structures.

A second feature of all-binary DMAs is that they may avoid material issues such as phase separation and ordering, which plague complex alloys. While phase separation and ordering affect the electronic and optical properties of a layered crystalline structure, it is their impact on dislocation kinetics of the structure that may have a substantial effect on the ultimate threading dislocation density (TDD) obtained, which directly impacts device performance and reliability. A low ultimate TDD is especially important for epitaxy on offcut substrates, which is necessary for heterovalent epitaxy (e.g. GaAs/Ge) as ternary alloys such as InGaAs that are grown on such substrates have shown a propensity for phase separation.

Although some possible benefits are described above with respect to a DMA buffer structure between two binary alloys, the first crystalline material and the second crystalline material need not be binary alloys. In some embodiments, the first crystalline material and/or the second crystalline material is an elemental material. In other embodiments, the first crystalline material and/or the second crystalline material may include complex alloys. For example, in some embodiments the first crystalline material of the first layer is GaAs, the second crystalline material is InGaAs, and the DMA buffer structure includes GaAs layers, InP layers and/or InAs layers. In principle, InGaAs layers can also be used in DMA buffer structures, but use of a complex material, such as a ternary or quaternary material, as a constituent buffer layer may detract from the advantages associated with all binary (or elemental) semiconductor layers.

In the structure depicted in FIG. 2A above, the first crystalline material (GaAs) of the first layer is a same material as the third crystalline material (GaAs) of the buffer layers, and the second crystalline material of the second layer (InP) is a same material as fourth crystalline material (InP) of the buffer layers. However, in other embodiments, the first crystalline material of the first layer may be a different crystalline material from the third crystalline material of the buffer layers and/or the second crystalline material of the second layer may be a different crystalline material from the fourth crystalline material of the buffer layers. For example, a crystalline layered structure may have a first layer of GaAs and a second layer of InP. A DMA buffer structure may include buffer layers of GaP and InP and/or buffer layers of GaAs and InAs. In some embodiments, a DMA buffer structure may include sets of GaP and InP constituent buffer layers and other sets of GaAs and InAs constituent buffer layers.

In some embodiments, an element present in the first crystalline material may also be present in the second crystalline material, but in other embodiments, the first crystalline material and the second crystalline material may have no elements in common.

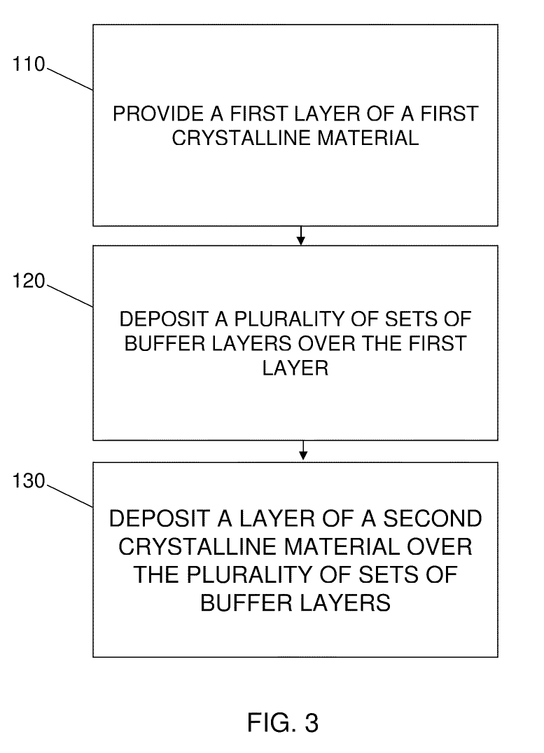

FIG. 3 is a flowchart schematically depicting a method of manufacturing a layered crystalline structure having a DMA buffer structure, in accordance with another embodiment of the invention. Initially, a substrate is provided having a surface with a first layer of a first crystalline material (step 110). A plurality of sets of buffer layers is deposited over the first layer (step 120), where each set of buffer layers comprises a DMA. Depositing each set of buffer layers includes depositing a buffer layer of a third crystalline material having a first thickness and depositing a buffer layer of a fourth crystalline material having a second thickness. A ratio of the first thickness to the second thickness for each set decreases with increasing separation between the first layer and the set. A layer of a second crystalline material is deposited over the plurality of sets of buffer layers (step 130).

As described above, the third crystalline material and the fourth crystalline material and thicknesses of each layer in each set are selected such that a set closer to the first layer has an effective lattice constant closer to that of the first layer than an effective lattice constant of a set further from the first layer. Similarly, a set closer to the second layer has an effective lattice constant closer to that of the second layer than an effective lattice constant of a set further from the second layer. The thickness of each constituent buffer layer of each set may be less than the respective critical thickness for each buffer layer, which may reduce the likelihood that each buffer layer relaxes independently as opposed to relaxing as a set.

In some embodiments, the substrate and at least one set of buffer layers are annealed to enhance stress relaxation in each set. The structure may be annealed after deposition of one set of buffer layers, after deposition of multiple sets of buffer layers, and/or after deposition of all sets of buffer layers. In some embodiments, the structure is annealed until at least 70% of the total misfit strain is relaxed in sets of buffer layers that have been deposited.

Other aspects of the invention are described below with respect to exemplary layered crystalline structures that we manufactured, studied and characterized. The examples below are meant to be illustrative and are not limiting.

### DMA Buffer Structure Design

As in a conventional analog graded buffer, one goal is to controllably engineer the lattice-constant from that of a given substrate to another value, on which device layers can subsequently be grown. As an example, we started with GaAs substrates, and we investigated applying the DMA concept to the lattice-constants between GaAs (5.6533 Å) and InP (5.8697 Å), seeking to obtain DMAs with various effective lattice-constants. For a DMA comprising alternating layers of two binary compounds A and B, one may assume that Vegard's law holds, and that the effective lattice-constant of the DMA constructed is described by the following equation:

$${a}_{DMA} = {x}_{A} {a}_{A} + {x}_{B} {a}_{B} = \frac{{t}_{A} {a}_{A}}{{t}_{A} + {t}_{B}} + \frac{{t}_{B} {a}_{B}}{{t}_{A} + {t}_{B}} ( {x}_{A} + {x}_{B} = 1 ) \qquad ( 1 )$$

where xA and xB are the mole fraction of compounds A and B respectively, a_{A} and a_{B} are the lattice constants of compounds A and B, t_{A} is the thickness of each A layer and t_{B} is the thickness of each B layer.

In the grading scheme described in Table 2 below and schematically depicted in FIG. 2A, grading from the binary endpoints of GaAs to InP is accomplished by the use of nine DMAs. The effective lattice-constant of each DMA (or binary endpoint) is a_{DMA}, while t_{GaAs} and t_{InP} are the layer thicknesses of each of the binary constituents in a period within a given DMA. The critical thicknesses of GaAs (t_{crit, GaAs}) and InP (t_{crit, InP}) can be obtained following Matthews-Blakeslee's force-balance calculations, as modified by Fitzgerald (E. A. Fitzgerald, Materials Science Reports 1991, 7, 87), and are given by

$${t}_{crit} = \frac{D ( 1 - v {cos}^{2} α ) [ ln ( {t}_{crit} \text{/} b ) + 1 ]}{Yf} \qquad ( 2 )$$

Here, D is the average shear modulus of the film and the underlying substrate (or DMA, in this case). The constants v, b and Y are the Poisson's ratio, Burgers vector and Young's modulus of the film respectively, and f is the mismatch between the film and the underlying substrate. In the material systems studied, 60° dislocations are the first to form, and α=60°.

The critical thicknesses represent the theoretical maximum thicknesses of each GaAs and InP constituent buffer layer in a particular DMA, assuming that the DMA is fully-relaxed and has an in-plane lattice-constant exactly equal to a_{DMA}, before relaxation and the formation of dislocations occur.

TABLE 2

| | | | | | | Total | | |
|---|---|---|---|---|---|---|---|---|
| | | | | | | DMA | | |
| | | | | | | thickness | t_{crit, GaAs} | t_{crit, InP} |
| DMA | % InP | a_{DMA} (Å) | t_{GaAs} (Å) | t_{InP} (Å) | # periods | (Å) | (Å) | (Å) |
| GaAs | 0 | 5.6533 | N/A | | N/A | N/A | N/A | 17 |
| GaAs | 0 | 5.6533 | N/A | N/A | | | N/A | 17 |
| DMA1 | 10 | 5.6749 | 90 | 10 | 10 | 1000 | 302 | 20 |
| DMA2 | 20 | 5.6965 | 40 | 10 | 20 | 1000 | 124 | 24 |
| DMA3 | 30 | 5.7182 | 23 | 10 | 30 | 990 | 71 | 29 |
| DMA4 | 40 | 5.7398 | 15 | 10 | 40 | 1000 | 46 | 35 |
| DMA5 | 50 | 5.7615 | 10 | 10 | 50 | 1000 | 33 | 45 |
| DMA6 | 60 | 5.7831 | 10 | 15 | 40 | 1000 | 24 | 60 |
| DMA7 | 70 | 5.8048 | 10 | 23 | 30 | 990 | 18 | 86 |
| DMA8 | 80 | 5.8264 | 10 | 40 | 20 | 1000 | 14 | 143 |
| DMA9 | 90 | 5.8481 | 10 | 90 | 10 | 1000 | 11 | 332 |

| | | | | | | | |
|---|---|---|---|---|---|---|---|
| InP | 100 | 5.8697 | N/A | N/A | N/A | 8 | N/A |

In the example grading scheme detailed in Table 2, the 3.7% lattice mismatch between InP and GaAs is bridged in 10% steps (i.e., each DMA has an effective lattice-constant that is different from the preceding DMA by 10% of the total lattice mismatch). The first DMA (DMA1) that is grown on GaAs is composed of 10% InP and 90% GaAs, in terms of thickness (10 Å InP and 90 Å GaAs), which, if fully relaxed, would have an effective lattice-constant of 5.6748 Å representing a decrease of 0.37% in the lattice mismatch relative to InP. The next DMA (DMA2), composed of 20% InP and 80% GaAs, would have an effective lattice-constant of 5.6963 Å, which represents a further 0.37% decrease in the lattice mismatch to InP, and so on. The thicknesses of the individual buffer layers of GaAs and InP for a given DMA(n) are chosen such that they are far below their respective critical thicknesses when grown on the underlying DMA(n−1). Choosing buffer layer thicknesses significantly below the respective critical thicknesses reduces the chance that the buffer layers each relax as individual layers, which would lead to the nucleation of a large number of dislocations.

The theoretical critical thicknesses calculated above assumes that underlying DMAs are fully relaxed, which may not be entirely accurate. An underlying DMA that is not fully relaxed may have in-plane lattice-constants that are smaller than expected, which would mean larger effective mismatch and therefore a smaller actual critical thicknesses. By choosing buffer layer thicknesses significantly below the theoretical critical thicknesses, each buffer layer is likely thinner than the actual critical thickness.

A DMA graded buffer grown as described in Table 2 will have a total thickness of 900 nm, with a uniform grading rate of approximately 4.1% mismatch/μm. This grading rate is much higher than typical grading rates used in conventional graded buffers. To achieve lower TDDs in the overlying layer, reduced grade rates must be used. This may be achieved by growing each DMA thicker (i.e., with more periods). The purpose of the foregoing was to test the concept, and using discrete 10% InP jumps simplified that task. In principle, it should be possible to achieve a continuous grade by continuously changing the thicknesses of the constituent DMA layers, which should yield superior TDD values.

### Experimental Details

As a proof of concept, multiple samples having DMA graded buffer structures have been grown based on the grading scheme defined in Table 2, or variations of it. The samples were grown by low-pressure metal-organic chemical vapor deposition (MOCVD) in a 7×2″ Aixtron/Thomas Swan close-coupled showerhead (CCS) configuration reactor. Pre-growth anneals, and all layers grown prior to the DMAs were carried out at a reactor pressure of 100 Torr, while DMA growths were carried out at 50 Torr, unless otherwise stated. Trimethylgallium (TMGa), trimethylindium (TMIn), arsine (AsH₃) and phospine (PH₃) were used as sources. Nitrogen was used as the carrier gas at a flow rate of 20 slpm. Specified growth temperatures were of the wafer surfaces, and were determined using optical pyrometry. The samples were grown on AXT semi-insulating epi-ready 2″ GaAs substrates. All growth was preceded by a 10-minute bake at the growth temperature under AsH₃ overpressure, followed by deposition of a 500-nm thick GaAs homoepitaxial layer. During all DMA growths, the flows of the source gases were kept constant, and only growth times were varied to effect the grading. The V/III-ratios during InP and GaAs layer growths were 270 and 20, respectively. When conventional analog graded buffers were grown for comparison, continuous linear compositional grading schemes were utilized, by constantly adjusting the TMIn and TMGa flows while keeping the AsH₃ flow constant, and the As/III-ratio varied from 35-66.

Cross-sectional transmission electron microscopy (X-TEM) was used to characterize the microstructural characteristics of the material and the layer thicknesses, while x-ray diffractometry (XRD) was used to measure film compositions, lattice-constants, and strain states, which were then correlated to the measured DMA layer thicknesses. This was done using both symmetric (400) and asymmetric (422) scans. Analysis of the XRD scans was performed assuming that Vegard's Law held for the GaAs/InP DMAs, and all relevant material parameters were obtained by linearly interpolating between the binary endpoints. Plan-view transmission electron microscopy (PV-TEM) was used to measure threading dislocation densities.

### Growth Challenges

The DMA graded buffer growths reported in this work were all carried out at relatively low temperature (for MOCVD) of 450° C., in order to minimize non-planarity and possible undesired relaxation (undesired relaxation is relaxation not related to the digital alloy ensemble). The low growth temperature also aids in suppressing the formation of 3-D islands. The main constraint that prevented us from going to lower temperatures was the poor pyrolysis of TMGa below 450° C., which would have resulted in excessively low growth rates, and which had been observed to lead to high amounts of carbon incorporation in films grown in our reactor ^{[16]}. Furthermore, as dislocation nucleation and glide are both thermally activated processes, we were concerned that poor relaxation kinetics might interfere with our goal of achieving controlled relaxation of the DMA graded buffer. Not surprisingly, growing complicated structures like DMAs entails several challenges, and the non-strain-symmetrized nature of the DMA further complicates matters. We identified and addressed several growth issues before being able to obtain DMA graded buffers that approached the design goal.

### Intermixing of GaAs/InP

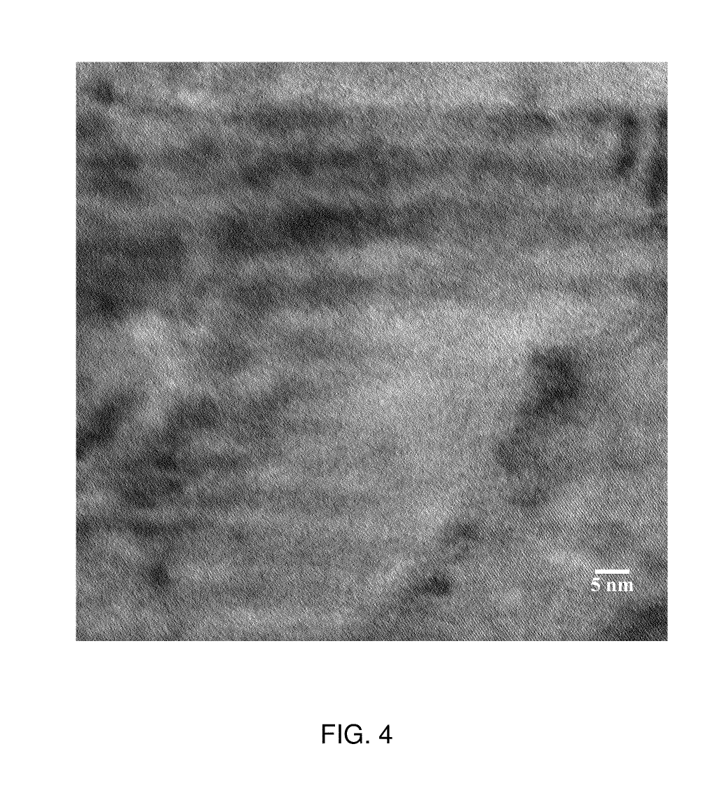

The gas switching sequence between growing alternating GaAs and InP layers had to be tailored to suppress intermixing between the DMA layers. For bulk layers, the simplest gas switching sequence to go from GaAs (InP)→InP (GaAs) would be to turn on (off) the flows of TMIn and PH₃, and turn off (on) the flows of TMGa and AsH₃ simultaneously. This would lead to a small amount of intermixing at the transition interface, typically on the order of several monolayers, which is generally not an issue for the growth of thicker layers. However, in our work, with targeted layer thicknesses as thin as 1 nm, the intermixing which resulted from such a switching sequence severely affected the quality of the DMAs grown. FIG. 4 is a cross-sectional transmission electron microscope (X-TEM) image that shows a DMA grown at 450° C. and a reactor pressure of 100 Torr with such a switching sequence.

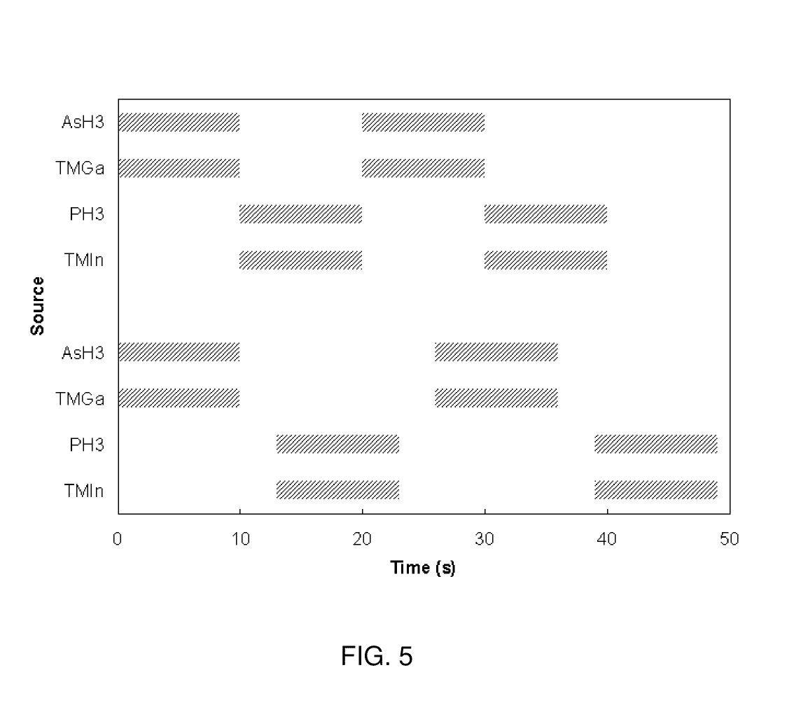

There is poor definition between the InP and GaAs layers, and the many different shades of contrast indicate the presence of intermixing between the species, effectively forming regions of InGaAsP alloys of varying compositions. This is clearly undesirable, as it means that a significant volume of the material is either a ternary or a quaternary alloy, which detracts from the aim of an all-binary structure. We investigated various growth conditions and gas switching sequences, and found desirable a 3 second pause between each layer, and a reduction of the reactor pressure to 50 Torr during DMA growth. FIG. 5 is a schematic diagram showing how the different gas switching schemes were executed. It is evident that the growth pauses add significantly to the total growth time, but they assist in achieving good DMA quality.

We theorize that the process modifications helped sweep the excess precursor species from a given layer out of the reaction chamber, ensuring that when growth of the subsequent layer started, it was done with only the appropriate species present in the gas phase, thereby reducing the amount of intermixing. By keeping our gas flows nominally the same, the reduced reactor pressure led to a shorter transit time of the gas species in the reaction chamber, and the length of the growth pause is estimated to be approximately the amount of time it takes to sweep the entire volume of our reaction chamber at 50 Torr.

### Growth Rate Variation

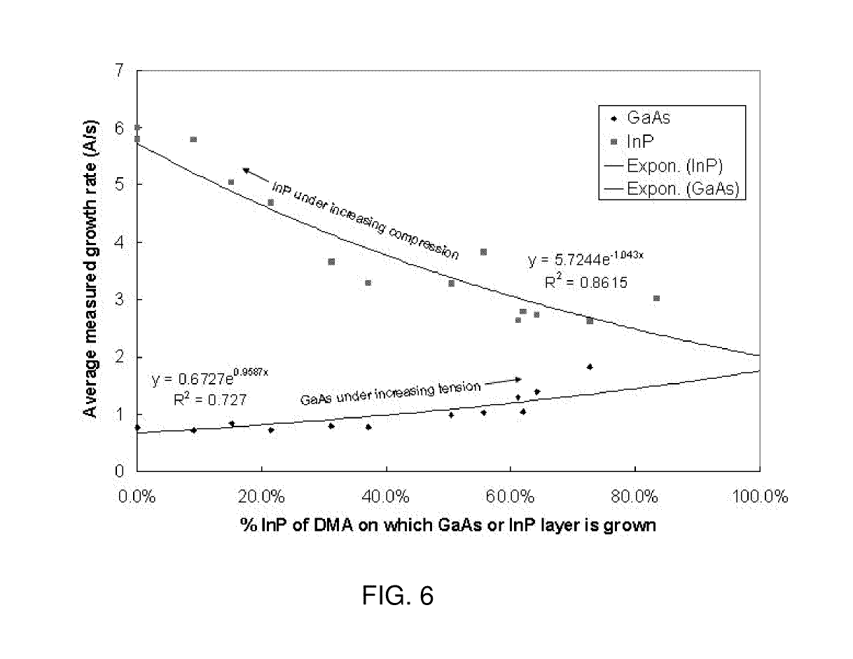

Another challenge was an unexpected variation in the growth rates of the InP and GaAs layers that make up the DMAs. In all the DMA growths, we controlled the layer thicknesses by keeping the source gas flows the same and varying the growth times for a given layer. We observed however that while growth rates of a given layer (i.e., InP or GaAs) were relatively constant from period to period within a given DMA, there was a strong dependence of the growth rate on which DMA it was in. FIG. 6 plots the trends we observed for InP and GaAs layer growth rates as a function of the composition (in terms of percentage, by thickness, of InP) of the underlying DMA. The data is presented this way because we expect each DMA to behave as a single, mechanically-uniform layer, and so the x-axis serves as a proxy for the in-plane lattice constant that the constituent InP and GaAs layers “see” during their growth. We note at this point, but elaborate later, that the data includes DMAs with different degrees of relaxation, which means that their compositions as measured by relative layer thicknesses are not entirely accurate, due to the distortion of the crystal lattice. We are also therefore unable to precisely determine the in-plane lattice-constant and mismatch that the InP and GaAs layers experience. We believe that this leads to the relatively large scatter in the data when the growth rates are plotted against DMA composition as has been done here.

As can be seen, the growth rate of the InP layers appears to decrease exponentially as a function of the composition of the underlying DMA, while the GaAs layer growth rate increases exponentially, albeit in a slower fashion. As III-V growth rates in MOCVD are typically limited by the Group-III species due to the presence of an excess Group-V overpressure, we naturally look towards factors that could influence the behavior of the In and Ga precursors to explain the observation. The low growth temperature of 450° C. usually suggests that changing pyrolysis rates of the metal organics (TMGa and TMIn), due to fluctuations in the wafer surface temperature, might be involved, thus affecting the layer growth rates ^{[14]}. However, the two divergent trends for InP and GaAs do not support this, and instead, suggest that the phenomena might be related to strain, given that the two layers experience biaxial strains in opposing directions (compression for InP and tension for GaAs). (An alternative explanation that might occur to some is that the growth rate depends on layer thickness, reflecting the presence of an incubation time, since for DMAs at lower InP compositions, the desired InP layer thicknesses are lower and GaAs layer thicknesses are higher. However, this is clearly not the case, as from Table 2, one can see that for InP layers, the targeted thicknesses remain constant at 1 nm for DMA compositions up to 50% InP, and likewise for GaAs layers, the targeted thicknesses are maintained at 1 nm for DMA compositions above 50% InP, and these composition ranges are where we observe the greatest changes in the growth rates of each of the layers).

An analysis may begin with consideration of the effect of biaxial compression on the out-of-plane lattice-constant (i.e., in the growth direction) of InP. For InP, the elastic constants are C₁₁=101.1 GPa and C₁₂=56.1 GPa, which results in a 2D Poisson's ratio of

$$v = 2 \frac{{C}_{12}}{{C}_{11}} = 1.1098 \qquad ( 3 )$$

For a cubic crystal, the relationship between the Poisson's ratio, the in-plane (parallel) lattice-constant and the out-of-plane (perpendicular) lattice-constant is

$${a}_{relaxed} = \frac{{a}_{⊥} + v \cdot {a}_{//}}{1 + v} \qquad ( 4 )$$

Thus, assuming a thin InP layer is grown on GaAs, and remains fully strained,

a_{⊥}=(1+v)·a_{InP}−v·a_{GaAs} (5)

Substituting the values a_{InP}=5.8697 Å and a_{GaAs}=5.6533 Å, an out-of-plane lattice-constant of 6.1099 Å is obtained for the fully-strained InP thin film, which represents a 4.1% increase over the equilibrium (relaxed) lattice-constant. Note that while biaxial strain can serve to distort the layer thickness measurements obtained through X-TEM, the magnitude of the distortion is small relative to the growth rate variations seen, and therefore the phenomenon of growth rate variation is real.

Kruger et al previously found that the growth rates and the incorporation rates of In relative to Ga in InGaN quantum wells (QWs) appeared to vary as more wells were grown in a MQW structure, which they attributed to the increase in compressive strain energy in the system as additional QWs were grown. While Kruger et al observed that growth rates increased with increasing strain energy, they did not explicitly state a trend in the In incorporation with strain, and therefore it is not clear if the growth rate increase was related to a lattice-constant increase in the film due to higher In content. Due to our use of all-binary layers, however, we can decouple the growth rate variation from any compositional effects on the lattice-constant, and our results suggest that in situations where a grown InP layer would experience higher compressive strain, such as nearer the start of growth where the lattice-constant is closer to the GaAs substrate, its growth rate is dramatically increased. This is somewhat consistent with the findings of Kruger et al published in J. Kruger, C. Kisielowski, R. Klockenbrink, G. S. Sudhir, Y. Kim, M. Rubin, E. R. Weber, in Gallium Nitride and Related Materials II Symposium, 1997, pp. 299.

Our data appears to indicate that when GaAs layers are grown under high tensile stress, the growth rates of the layers are increased. This implies that high strain conditions lead to enhanced growth rates for films that are grown with the same sign of strain. However, the origin of this effect is unclear because from the standpoint of minimization of system energy, it would be favorable for the trends to be reversed—i.e. under higher strain conditions, the system would seek to suppress layer growth that would lead to even higher strain build up, and instead favor layer growth that would lead to a reduction in the overall strain. Explanations that have been invoked for energetically unfavorable (in the bulk) segregation and clustering in ternary and quaternary alloys generally have focused on local non-equilibrium conditions at the surface such as surface roughness and local strain variations due to different cation-anion bonds present in the alloys. However, these do not appear to be relevant to the growth of binary compounds in these experimental results, which means that the local variation of incorporation rates of a cation (or anion) species over another is not an issue. Furthermore, the surface-type effects on growth rates can be ruled out, because the InP layers are always grown on GaAs surfaces, and vice versa, in contrast with conventional growth of binary layers on analog buffers (e.g. InP growth on InGaAs buffers), where different strain conditions are always accompanied by different surface species.

Regardless, it appears that the varying effective mismatch between the layer being deposited and the growth surface at different points in the DMA graded buffer is responsible for this effect, given that this is the main difference between the present work and conventional strain-balanced or unstrained SLs, where growth rate variations have not been reported. The observed growth trends might be an indication of the physics behind two other surface-related phenomena—those of cross-hatch formation and phase separation due to the effect of strain on the growth surface. Strain fields associated with misfit dislocations have been known to lead to local growth rate variations, leading to characteristic undulations on the surface known as cross-hatch; however, the explicit effect the strain fields have on the growth rate have not be fully understood.

The results presented herein appear to indicate that for a surface with regions under both compressive and tensile strain, growth of a compressively-strained layer would be enhanced at regions under compressive strain and depressed at regions under tensile strain, while the reverse would be expected for the growth of a tensile-strained layer. This might also explain the differences in surface morphology between tensile- and compressive-graded buffers that have been observed by others. Extending this analysis might also touch upon the mechanism for phase separation. During graded buffer growth in a ternary alloy system such as InGaAs, the component binaries InAs and GaAs would in general experience opposite signs of strain on a given growth surface. The phenomena observed in this work would suggest that regions of the surface under compressive strain would see enhanced In incorporation, while regions of the surface under tensile strain would similarly see enhanced Ga incorporation. This would lead to phase separation of the ternary alloy into In-rich and Ga-rich regions. Thus, strain fields of larger magnitudes may be expected to increase the likelihood of phase separation occurring, which is consistent with the increased phase separation observed for faster grade rates.

These experiments have shown that small growth variations in earlier DMAs can lead to differences in the thicknesses and strain states of the subsequent DMAs, as the InP and GaAs layer growth rates would be affected in non-linear ways. Thus, growth rate control in the strained DMA system is not easily achieved, and must be characterized over multiple iterations, due to the interplay between growth rate, layer thickness, digital alloy composition, degree of relaxation and lattice-constant.

### Critical Thickness Constraints

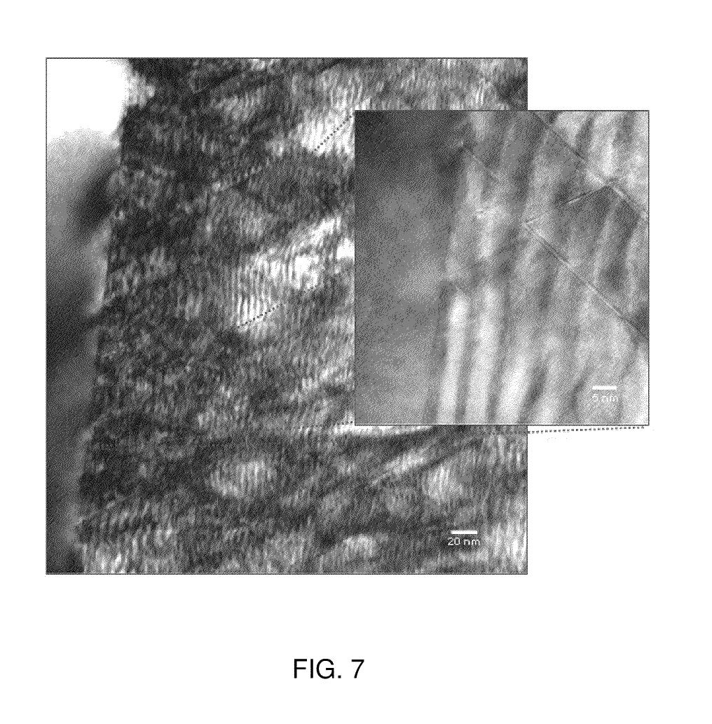

Solving the intermixing issue permits manufacture of well-defined DMA layers, and characterizing the growth rates of the InP and GaAs layers at any point in the DMA graded buffer allows enables accurate construction DMAs of the appropriate composition. Another aspect of DMA growth that we found to be important for achieving relatively low threading dislocation densities (TDDs) was ensuring that the individual layers do not reach their individual critical thicknesses and start to relax independently of each other. FIG. 7 is a cross-sectional transmission electron microscope (X-TEM) image of a DMA graded buffer grown on a GaAs substrate that was inadvertently grown with an InP layer thickness of approximately 2.5 nm for the first DMA on the GaAs homolayer.

As can be seen from Table 2, an InP layer thickness of approximately 2.5 nm is beyond the critical thickness of InP on GaAs, and therefore relaxation of the InP is expected. The X-TEM image shows that uncontrolled relaxation of the InP layer resulted in many defects propagating through the entire DMA structure, which also contributed to the rapid roughening of subsequent DMA layers. The inset in FIG. 7 shows that that the defects are predominantly stacking faults that appear to originate in the InP layers, which is unexpected because it is usually tensile strain that leads to the separation of dislocations into two partial dislocations, resulting in stacking faults. This image demonstrates the importance of keeping constituent buffer layers well below the critical thickness, which places practical limits on the design and growth of a DMA graded buffer.

For example, as indicated by the data in Table 2, the 3.7% lattice-mismatch between GaAs and InP means that the use of these layers to bridge the lattice-constants of the same binary endpoints results in minimum critical thicknesses on the order of 1 nm. This implies means that growth may need to be controlled to that level of accuracy, which may places limits on the maximum achievable growth rate. Furthermore, the limitation on critical thickness also increases the number of periods necessary to achieve a certain grade rate (recall that this is determined by the total thickness of each DMA). Because a growth pause may be desirable when switching between InP and GaAs growth, increasing the number of periods in each DMA may leads to overall longer growth times. For the exemplary DMA buffer structures produced and described herein, growth times of three or more hours were common, depending on how far the DMA graded buffer structure was graded.

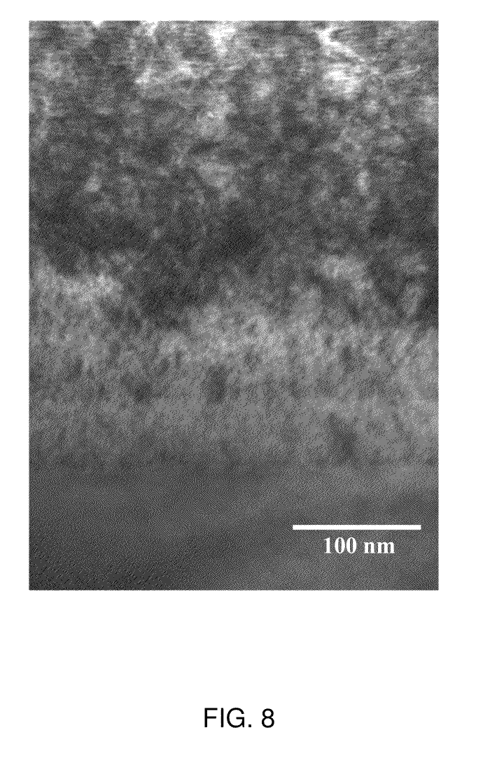

Second, the critical thickness limit may also place some restrictions on options for materials usable for a particular DMA graded buffer. In theory, an all-binary alloy DMA concept can be applied with any two binary compounds, as long as their lattice-constants span at least as wide a range as those of the desired start- and end-points (GaAs and InP respectively, in this case). Based solely on this criterion, a DMA graded buffer using InP and GaP as the constituent layers of the DMAs, was investigated to examine possible effects of the absence any anion intermixing effects on the resultant DMA buffer structure. The critical thickness of GaP on GaAs is ˜11 Å, and it decreases as lattice-constants move closer to those of InP. As the lattice-constant of GaAs is almost exactly midway between GaP and InP, we started with a nominally 1 nm:0.95 nm GaP:InP DMA, which would have an effective lattice-constant almost equivalent to GaAs. Following that, the thickness of the InP layer was increased accordingly, while the thickness of the GaP layer was maintained at 1 nm, until the DMA graded buffer was graded to InP. Each DMA was designed to have a total thickness of 100 nm. FIG. 8 is an X-TEM image of this DMA graded buffer constructed with InP and GaP layers. The GaAs appears at the bottom of the image.

The image in FIG. 8 is centered on the first three DMAs, which look somewhat better than the rest of the DMAs, and are most easily identified. The total thickness of each of the first three DMAs are approximately only half the thickness expected. For this experiment utilizing GaP/InP DMAs, the TMGa and TMIn gas flows used were identical to those used for the GaAs/InP DMAs, and it was assumed that the GaP/InP layers would have the same growth rates as those presented in Table 2. The fact that the growth rates were not as predicted suggests a growth rate variation due to the mismatch present between the growth surface and the GaP and InP layers. Due to the poor quality of the layers, accurate measurement of the individual layer thicknesses was not possible, especially for the first few DMAs which were composed of layers that were only 1-2 nm. The first few DMAs were likely highly intermixed (i.e. essentially ternary alloys), which may explain the lack obvious dislocations indicating stress relaxation, such as those appearing in FIG. 7. Furthermore, X-ray diffraction (XRD) of the (400) family of planes (not shown here) revealed three weak peaks apart from the GaAs substrate and InP cap peaks, indicating the presence of ternary alloys In_{0.34}Ga_{0.66}P, In_{0.51}Ga_{0.49}P and In_{0.68}Ga_{0.32}P. While not entirely accurate, because the films are not necessarily fully relaxed, the observation that the second DMA seems to be roughly lattice-matched to the GaAs substrate and that the third DMA is the first with a lattice-constant larger than GaAs, may suggest that GaP films on the order of ˜1 nm relax uncontrollably starting after the third DMA. This is likely the reason for the drastic increase in defect density starting from the fourth DMA in FIG. 7. X-TEM images at higher magnification (not shown here) also confirmed that the GaP and InP layers were more distinct from the fourth DMA onwards, and stacking faults were once again visible starting from this point.

### Results and Discussion

The preceding sections detailed some important factors for successful growth of the DMAs. By applying these factors, we grew DMA graded buffers with varying compositions. The work reported in this section all use the grading scheme detailed in Table 2, unless otherwise noted. Table 3 lists the DMAs discussed in this section.

TABLE 3

| | Final composition | |
|---|---|---|
| DMA graded buffer | (% InP) | Capped? |
| DMAGB1 | 30% | No |
| DMAGB2 | 60% | 43% InGaAs |
| DMAGB3 | 100% | InP |
| DMAGB4 (Hybrid) | 100% | InP |

### DMAGB1—DMA Graded Buffer to Low (30%) InP Composition; Uncapped

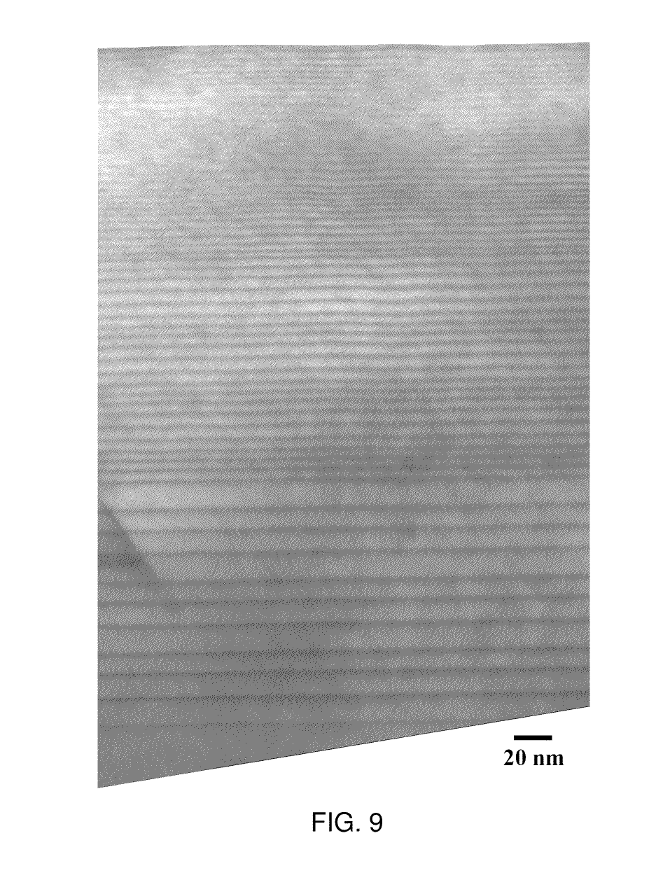

DMAGB1 was grown, which consisted of the first three DMAs listed in Table 2, using growth conditions and times selected to create a DMA buffer structure having a low TDD. FIG. 9 is an X-TEM image of DMAGB1 and Table 4 contains XRD data from this sample.

TABLE 4

| | Relaxed | | | | |
|---|---|---|---|---|---|
| | lattice- | | % InP | % InP in DMA | % |
| | constant | | in DMA | (XRD; out-of- | InP in DMA |
| Peak | (Å) | Relaxation | (XRD) | plane) | (X-TEM) |
| DMA1 | 5.6653 | −0.09% | 5.55% | 11.89% | 13.73% |
| DMA2 | 5.6805 | 4.72% | 12.58% | 22.32% | 23.07% |
| DMA3 | 5.6963 | 4.01% | 19.91% | 36.73% | 34.94% |
| 92% InP | 5.8542 | 99.15% | N/A | N/A | N/A |

The X-TEM image shows relatively flat and well-defined layers, and the three DMAs can be readily identified, though there is slight variation in the layer thicknesses within each DMA. The variation in layer thicknesses may be attributed to poor heater control during the growth, which led to temperature swings of ±3° C. While this image is taken in an on-pole condition, images taken in a g=<022> two-beam diffraction mode for enhanced dislocation contrast revealed few signs of misfits which would signify the relaxation of the DMAs. The XRD data confirms this—three peaks that were attributable to the three different DMAs could be found in both the symmetric (400) and asymmetric (422) scans that were taken, and all three were found to exhibit negligible amounts of relaxation. The apparent discrepancy between the DMA compositions as measured by XRD (column 4 in Table 3) and those as calculated from measured layer thicknesses in X-TEM (column 6 in Table 3) can be explained by the effects of biaxial strain on the fully-strained layers. As the XRD data of the out-of-plane lattice-constant shows, there is much better agreement between the equivalent DMA compositions obtained from the out-of-plane lattice-constant (column 5 in Table 3), and those obtained through X-TEM. This, however, reveals a complication in controlling DMA growth. The grading scheme used is predicated on the assumption that the composition of each DMA can be controlled by paying attention to the GaAs and InP layer thicknesses within the DMAs. However, these results show the significant effect residual strain has on the relationship between layer thicknesses and the relative atomic mole fractions of GaAs in InP in the DMAs. This means that an optimized growth process may need to take into account the strain states of the DMAs to make adjustments to growth times. However, accurate information regarding the strain state, which is may be obtained through XRD measurements, is not always available, because when the DMAs start to relax, the strength of the XRD signals from the DMAs start to weaken, due to their reduced coherency. Due to this, all of the growths reported here were still designed according to data obtained through layer thickness measurements (with slight adjustments according to available strain state information), and assumptions about DMA compositions were checked when meaningful XRD data was available.

A final observation is that there is a last peak in each of the XRD scans that corresponds to an almost fully-relaxed layer that is 92% InP, 8% GaAs by composition. This peak is actually a feature that is common to all of the GaAs/InP DMA growths presented herein, and is often one of the strongest peaks apart from the substrate, which suggests that it is the aggregated signal from all the individual InP layers in the various DMAs. The almost fully-relaxed state of this layer, even in samples like this one where the DMAs are almost fully-strained, is unexplained and may need further investigation.

DMAGB2—DMA Graded Buffer to Moderate (60%) InP Composition; Capped with In_{0.43}Ga_{0.57}As

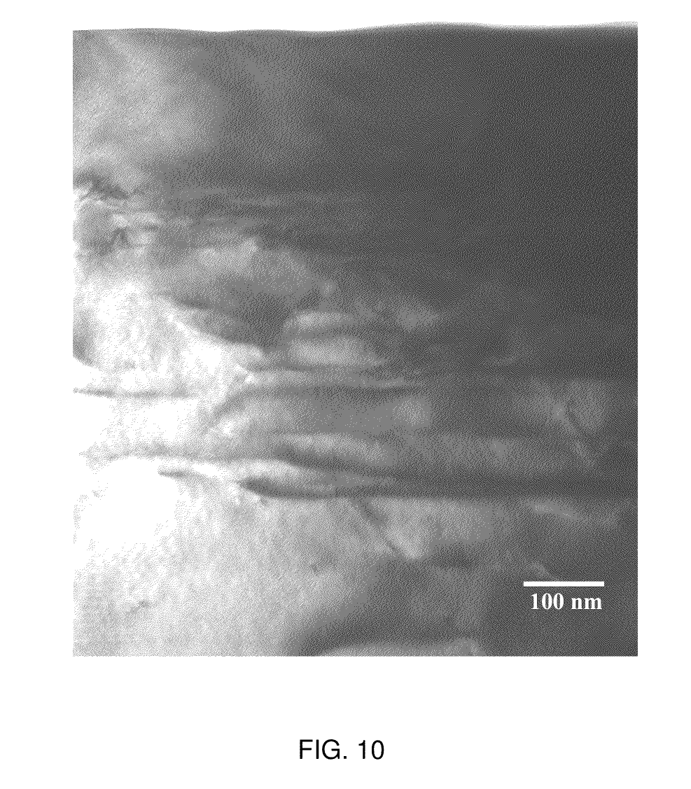

Further grading was further investigated in DMAGB2, to approximately 60% InP according to layer thickness measurements, and an attempt was made to cap the grading with a lattice-matched InGaAs layer. If the final DMA composition was accurate and fully-relaxed, it would possess the lattice-constant of In_{0.32}Ga_{0.68}As. FIG. 10 depicts DMAGB2 and Table 5 summarizes data obtained from XRD measurements and an X-TEM image of the structure.

TABLE 5

| | | | | % InP in | |
|---|---|---|---|---|---|
| | | | | DMA | |
| | Relaxed | | % InP | (XRD; | % InP |
| | lattice- | | in DMA | out-of- | in DMA |
| Peak | constant (Å) | Relaxation | (XRD) | plane) | (X-TEM) |
| DMA1 | N/A | N/A | No peak | 10.46% | 12.55% |
| DMA2 | N/A | N/A | No peak | 21.57% | 25.71% |
| DMA3 | N/A | N/A | No peak | No peak | 32.16% |
| DMA4 | N/A | N/A | No peak | No peak | 44.04% |
| DMA5 | N/A | N/A | No peak | No peak | 48.18% |
| DMA6 | N/A | N/A | No peak | 57.48% | 55.36% |
| 43% InGaAs | 5.8284 | 82.84% | N/A | N/A | N/A |
| 94% InP | 5.8564 | 99.95% | N/A | N/A | N/A |

It is clear from the data and the image that while DMAGB1 remained fully-strained, the various DMAs of DMAGB2 experienced significant amounts of relaxation, as evidenced by the misfit network present in X-TEM images of the sample. This may be attributed to increased amounts of strain built up by the additional DMAs, and the InGaAs cap layer which was significantly more compressively strained than expected. It appears from FIG. 10 that there is a higher density of misfits at the junctions of the various DMAs, as compared to regions within a given DMA, especially for earlier layer when less strain had been built up in the structure. This suggests that each DMA behaves somewhat like a discrete mechanically-uniform material, and thus the relaxation initiates at the start of each DMA. Also, there appears to be a higher concentration of misfit dislocations, signifying increased relaxation, in the latter DMAs. This may explain why DMA peaks for the latter DMAs were not as readily observable in XRD, especially in the (422) scans, as the DMAs are no longer as coherent. However, because the relaxation is not expected to initiate from the earlier layers, it appears that relaxation in this case might be driven by the highly mismatched InGaAs cap layer. We speculate that the DMAs closer to the surface might be “screening” those closer to the substrate, leading to the misfit network characteristics observed in this sample. Nevertheless, we believe that the presence of a relatively clean InGaAs cap, despite the lack of proper lattice-matching, may indicate the viability of the DMA graded buffer.

### DMAGB3—DMA Graded Buffer to InP; Annealed

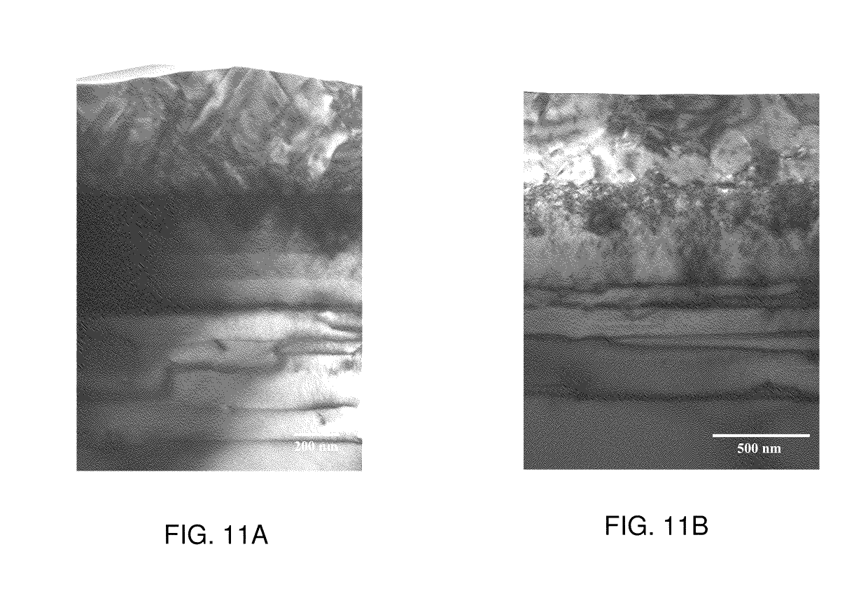

DMAGB3 was a full structure as laid out in Table 2, and included an approximately 400-nm thick InP cap. After growth, the sample was retrieved from the MOCVD reactor, and cleaved into two halves, one of which was returned to the reactor to be annealed. The flow of PH₃ was started at 250° C., and from that point on, the temperature was ramped up to 650° C. over 6 min. After reaching 650° C., the sample was annealed in the PH₃ ambient for a further 20 min, before being cooled. FIGS. 11A and 11B are X-TEM images of DMAGB3 before and after annealing, respectively.

As grown, DMAGB3 had a very rough surface. As can be seen in FIG. 9A , the InP cap layer exhibits large densities of stacking faults and other extended defects. While there were clear signs of misfit dislocations forming in the first four or five DMAs, they did not seem to be present in the same form in the later DMAs. Higher magnification images of the DMAs revealed that the fifth and sixth DMAs were relatively clean and free of defects, but the seventh through ninth DMAs had numerous stacking faults running through them. Also, the GaAs and InP layers in the first five DMAs were relatively flat and distinct, but starting from the sixth onwards, they became increasingly undulated, and thus accurate measurements of their layer thicknesses were not possible. No DMA peaks were visible in the (422) XRD scan, and only five were seen in the (400) XRD scan. The anneal at 650° C. appeared to improve the surface morphology greatly, likely due to thermal deformation of the InP at high temperatures, which has been found to result in flatter InP surfaces. Crystalline quality was also improved, as evidenced by the reduction of the stacking fault density in the InP cap. However, as shown by the X-TEM image, the DMAs did not appear to be significantly changed, in terms of layer thicknesses, the misfit networks and the defects present. From higher magnification images (not shown here), there was also no sign of increased intermixing between the DMA layers, which means that bulk diffusion is negligible at 650° C. However, XRD scans showed the largest difference between the structure before and after annealing. Peaks attributable to most of the DMAs could be observed fairly readily after the anneal. The post-anneal results, together with available measured layer thicknesses, are tabulated in Table 6. Given that increased DMA relaxation is expected to reduce peak intensity, this suggests that the anneal did not significantly drive DMA relaxation as had been hoped, and the main effect was probably the improvement of the quality of the InP cap. It was noted that for uncapped DMA graded buffer samples (not shown here), anneals served to greatly roughen the surface, which may be attributed to significant intermixing of the thin GaAs and InP layers that result from high surface diffusivities.

TABLE 6

| | | | | % InP | |
|---|---|---|---|---|---|
| | | | | in DMA | |
| | Relaxed | | % InP | (XRD; | |
| | lattice- | | in DMA | out-of- | % InP in DMA |
| Peak | constant (Å) | Relaxation | (XRD) | plane) | (X-TEM) |
| DMA1 | 5.6629 | 37.25% | 4.45% | 6.07% | 7.42% |
| DMA2 | 5.6733 | 34.14% | 9.25% | 14.08% | 12.16% |
| DMA3 | 5.6867 | 41.86% | 15.44% | 24.63% | 26.33% |
| DMA4 | 5.7045 | 66.98% | 23.70% | 32.04% | 30.00% |
| DMA5 | 5.7168 | 55.37% | 29.38% | 41.01% | 42.25% |
| DMA6 | 5.7295 | 52.46% | 35.23% | 51.31% | Not measurable |
| DMA7 | 5.7454 | 46.30% | 42.55% | 64.00% | Not measurable |
| DMA8 | 5.7597 | 48.45% | 49.17% | 72.97% | Not measurable |
| DMA9 | N/A | N/A | No peak | No peak | Not measurable |
| InP | 5.8686 | 96.03% | N/A | N/A | N/A |

The data in Table 6 illustrates a problem with designing the growth around measured DMA layer thicknesses. While there is no data for DMA9, it is likely that after the final DMA, the digital alloy composition is of no more than 55% InP. The low relaxation values of the DMAs further mean that the in-plane lattice-constant of the topmost DMA is significantly smaller than that of InP. Therefore, it is not unexpected that the InP cap deposited at the top of the DMA is highly defective, due to the large effective lattice-mismatch. Another observation that can be drawn from the data is that the DMA relaxation peaks at about 67% for DMA4, which is in the middle of the DMA structure. This is somewhat consistent with what was observed for DMAGB1, where DMAs up to 30% InP did not undergo relaxation. From these observations, it appears that at the grading rate present in these DMAs (approximately 1.9% strain/μm, or half of the originally intended 3.7% strain/μm), it may only be preferential for plastic deformation of the DMAs to occur after DMA4 is grown. It further appears that a given DMA's relaxation may be driven by the increasing tensile strain it experiences from the DMAs grown after it.

DMAGB4—Hybrid Conventional Graded Buffer+DMA Graded Buffer; Capped with InP

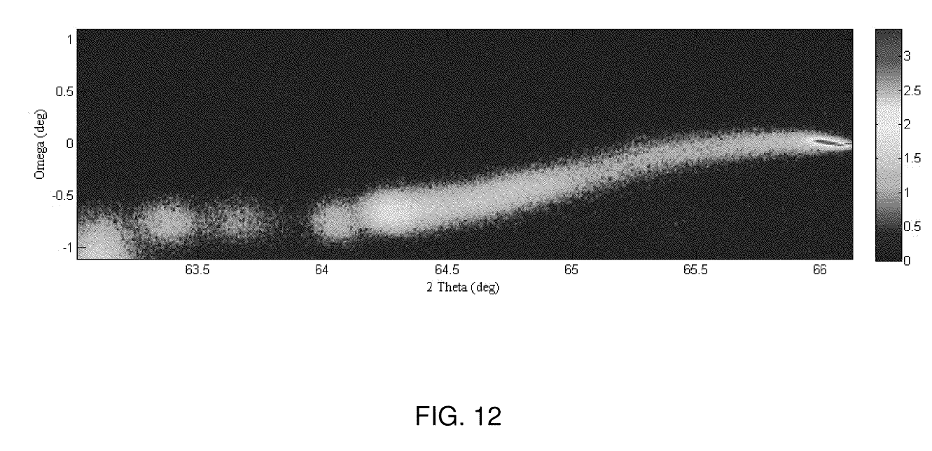

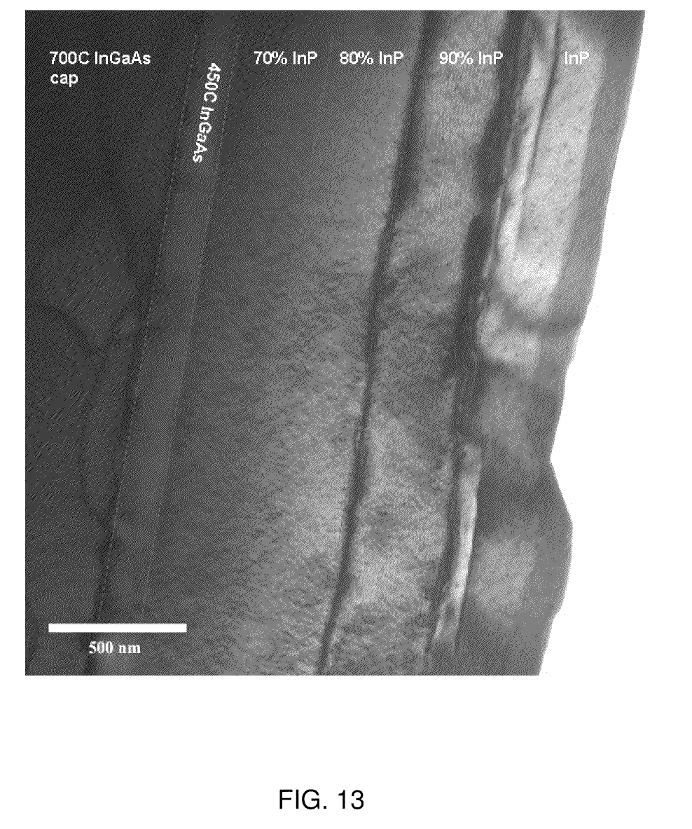

The previous results indicate that control over the composition and relaxation may need to be improved for a DMA graded buffer structure to achieve its full potential. Nevertheless, to ascertain the usefulness of the DMAs for circumventing the problem of phase separation in a ternary InGaAs alloy, a hybrid InGaAs graded buffer plus DMA graded buffer structure was grown. The intention was to start with a high quality virtual substrate capped with In_{0.32}Ga_{0.68}As, before phase separation of the InGaAs alloy occurs, and continue grading towards InP with a DMA graded buffer comprising three DMAs. The random-alloy InGaAs graded buffer was grown at 700° C. with a grade rate that varied from 1.2% misfit/μm at the start of the buffer to 0.5% misfit/μm at the end. This was followed by a 1 μm InGaAs cap layer. The temperature was then ramped down to 450° C., while maintaining an AsH₃ overpressure over the wafer. At 450° C., a 150 nm lattice-matched InGaAs layer was grown, followed by the DMAs of nominally 70%, 80% and 90% InP. This was followed by a 400 nm thick InP cap, also grown at 450° C. In an effort to promote improved DMA relaxation, the grading rate was reduced to a third of that described in Table 2, by tripling the number of periods in each DMA. An XRD reciprocal space map of the (400) family of planes is shown in FIG. 12 and an X-TEM image of the top of the hybrid InGaAs graded buffer plus DMA graded buffer is shown in FIG. 13.

The continuous XRD signal spanning 2θ values of approximately 64.25° to 66.00° is characteristic of the continuously-graded InGaAs random-alloy buffer, with the peak at 64.25° corresponding to the InGaAs graded buffer cap. The four distinct peaks to the left of that represent, from right to left, the three DMAs and the InP cap. XRD revealed that the InGaAs graded buffer cap had an indium mole fraction of 32.9%, and was well-relaxed (91.30% relaxation), which meant that it had bridged approximately 60% of the lattice-mismatch between GaAs and InP, as intended. The actual composition of the final DMA was 79.12% InP, and it was 78.03% relaxed, which meant that there was still a large effective lattice-mismatch between the InP cap and the topmost DMA. However, the InP cap in this sample appeared to be free of threading dislocation throughout the X-TEM foil, which means that the hybrid structure could potentially have a low TDD. This is in contrast with the InP cap of DMAGB3, which was grown at the same temperature, but exhibited a large number of defects both pre- and post-anneal. We believe that the difference is due to the more complete (in terms of bridging the lattice-mismatch) grading present in DMAGB4. This would confirm that the DMAs are relaxing in a similar fashion as ternary materials, providing evidence that DMAs can be used as a means to achieve high quality virtual substrates that may be superior to those obtained through the more conventional approach of compositional grading. Meaningful PV-TEM analysis could not be carried out on this sample, as the thin cap meant that underlying misfit dislocations would be visible in the TEM foil and interfere with the measurement.

As described above, producing a DMA that behaves similarly mechanically to the desired random alloy, may require controlling constituent layer thicknesses to limit thicknesses to below critical thickness values. This may require a characterization of the growth rate dependencies on strain/underlying surface. When dealing with DMAs encompassing a large mismatch, such as grading from GaAs to InP, multiple anneals may be performed at multiple stages to drive DMA relaxation. If periodic anneals are not performed, rampant dislocation nucleation may occur. Therefore, when grading over a large lattice-constant range (GaAs lattice-constant to InP lattice-constant), periodic annealing may be especially beneficial. Although the examples shown use binary constituent layers of GaAs and InP in the DMAs, the concept can be equally applied to other binary and elemental semiconductors, as we have noted above, with similar advantages realized in the material systems. Hybrid structures combining conventional random-alloys with DMAs to form graded buffers have also been demonstrated, and confirm that DMAs may avoid materials growth issues such as phase separation and ordering present with complex alloys.

Although the DMA graded buffer structures studied were deposited using low-pressure metal-organic chemical vapor deposition (MOCVD), one of ordinary skill in the art would recognize that the claimed methods and structures are not limited to those employed or manufactured by MOCVD. Other techniques that could be employed for manufacturing DMA graded buffer structures include, but are not limited to: molecular beam epitaxy (MBE); migration enhanced epitaxy (MEE); atomic layer deposition/epitaxy (ALD/ALE); chemical vapor deposition (CVD) and vapor phase epitaxy (VPE); or any other technique for epitaxial deposition or growth of crystalline layer. For some systems, liquid phase epitaxy/hydride phase vapor epitaxy (LPE/HVPE) or plasma-assisted/laser assisted techniques may be employed.

This invention is not limited in its application to the details of construction and the arrangement of components set forth in the foregoing description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A layered crystalline structure comprising:
a first layer disposed comprising a first crystalline material having a first in-plane lattice constant;
a second layer disposed over the first layer and comprising a second crystalline material having a second in-plane lattice constant that is mismatched with the first in-plane lattice constant; and
a first plurality of sets of buffer layers disposed between the first layer and the second layer, each set comprising:
a buffer layer comprising a third crystalline material; and
a buffer layer comprising a fourth crystalline material;
wherein a ratio of a thickness of the buffer layer comprising the third crystalline material to a thickness of the buffer layer comprising the fourth crystalline material for each set decreases with an increasing separation between the first layer and the set.

2. The layered crystalline structure of claim 1, wherein a thickness of each buffer layer in each set is less than a critical thickness for threading dislocation formation in the buffer layer.

3. The layered crystalline structure of claim 2, wherein the fourth crystalline material and the second crystalline material comprise a same crystalline material.

4. The layered crystalline structure of claim 1, wherein the fourth crystalline material and the second crystalline material comprise a same crystalline material.

5. The layered crystalline structure of claim 1, wherein the third crystalline material and the first crystalline material comprise a same crystalline material.

6. The layered crystalline structure of claim 1, wherein each buffer layer set has an effective in-plane lattice constant with a value between the in-plane lattice constant of the first layer and the in-plane lattice constant of the second layer.

7. The layered crystalline structure of claim 1, wherein the first layer comprises a substrate.

8. The layered crystalline structure of claims 1, wherein the first layer is disposed on a substrate.

9. The layered crystalline structure of claim 1, further comprising a second plurality of sets of buffer layers disposed over the first plurality of sets of buffer layers, the second plurality of sets of buffer layers comprising:
a buffer layer comprising a fifth crystalline material; and
a buffer layer comprising a sixth crystalline material; wherein a ratio of a thickness of the buffer layer comprising the fifth crystalline material to a thickness of the buffer layer comprising the sixth crystalline material for each set decreases with an increasing separation between the first layer and the set.

10. The layered crystalline structure of claim 9, wherein the fourth crystalline material and either the fifth crystalline material or the sixth crystalline material comprise a same crystalline material.

11. The layered crystalline structure of claim 1, wherein the third crystalline material and/or the fourth crystalline material comprise elemental materials.

12. The layered crystalline structure of claim 1, wherein the third crystalline material and/or the fourth crystalline material comprise binary compounds.

13. The layered crystalline structure of claim 1, wherein the buffer layers are epitaxial with the first layer, and the second layer is epitaxial with the buffer layers.

14. The layered crystalline structure of claim 1, wherein the first crystalline material and/or the second crystalline material is a semiconductor.

15. The layered crystalline structure of claim 1, wherein the misfit strain in each set of buffer layers is at least about 70% relaxed.

16. The layered crystalline structure of claim 1, wherein the mismatch between the first in-plane lattice constant of the first layer and the second in-plane lattice constant of the second layer is at least about 0.3%.

17. The layered crystalline structure of claim 1, wherein each set of buffer layers further comprises:
a second buffer layer comprising the third crystalline material; and
a second buffer layer comprising the fourth crystalline material.

18. The layered crystalline structure of claim 17, wherein a thickness of the buffer layer comprising the third crystalline material is about equal to a thickness of the second buffer layer comprising the third crystalline material, and a thickness of the buffer layer comprising the fourth crystalline material is about equal to a thickness of the second buffer layer comprising the fourth crystalline material for each set.

19. The layered crystalline structure of claim 1, wherein the buffer layers comprise exclusively elemental and/or binary materials.

20. A layered crystalline structure comprising:
a first layer comprising a first crystalline material having a first in-plane lattice constant;
a second layer disposed over the first layer and comprising a second crystalline material having a second in-plane lattice constant that is mismatched with the first in-plane lattice constant; and
a first plurality of sets of buffer layers disposed between the first layer and the second layer, each set comprising:
a buffer layer comprising a third crystalline material; and
a buffer layer comprising a fourth crystalline material;
each set of buffer layers having an effective in-plane lattice constant with a value between the lattice constant of the first layer and the lattice constant of the second layer, and a magnitude of a difference between the second in-plane lattice constant and the effective in-plane lattice constant of a set decreasing with increasing separation between the set and first layer.

21. The layered crystalline structure of claim 20, wherein a thickness of each buffer layer in each set is less than a critical thickness for threading dislocation formation in the buffer layer.

22. The layered crystalline structure of claim 20, wherein the third crystalline material and/or the fourth crystalline material comprises a binary compound.

23. The layered crystalline structure of claim 20, wherein the third crystalline material and/or the fourth crystalline material comprises an elemental material.

24. The layered crystalline structure of claim 20, further comprising a compositionally graded buffer structure disposed between the first layer and the second layer.

25. A layered crystalline structure comprising:
a first layer comprising a first crystalline material having a first in-plane lattice constant;
a second layer comprising a second crystalline material disposed over the first layer and having a second in-plane lattice constant that is mismatched with the first in-plane lattice constant; and
a plurality of sets of buffer layers disposed between the first layer and the second layer, each set comprising:
a buffer layer comprising a third crystalline material; and
a buffer layer comprising a fourth crystalline material; each set having a substantially relaxed strain such that a threading dislocation density in the second layer is less than 10⁸ dislocations per cm².

26. A digital metamorphic alloy buffer for transitioning from a lattice constant of an underlying layer to a lattice constant of a lattice mismatched overlying layer comprising:
a first constituent buffer layer comprising a first crystalline material having a first lattice constant; and
a second constituent buffer layer comprising a second crystalline material having a second lattice constant; wherein an effective lattice constant of the digital metamorphic alloy buffer has a value between a lattice constant of the underlying layer and a lattice constant of the overlying layer and wherein a thickness of each buffer layer is less than a critical thickness for threading dislocation formation for each buffer layer.

27. A method of manufacturing a layered crystalline structure comprising:
providing a first layer of a first crystalline material;
depositing a plurality of sets of buffer layers over the first layer, depositing a set in the plurality comprising
depositing a buffer layer of a third crystalline material having a first thickness; and
depositing a buffer layer of a fourth crystalline material having a second thickness, a ratio of the first thickness to the second thickness decreasing with increasing separation between the first layer and the set for each set; and
depositing a layer of a second crystalline material over the plurality of sets of buffer layers.

28. The method of claim 27, wherein a thickness of each buffer layer is less than a critical thickness for threading dislocation formation in the buffer layer.

29. The method of claim 27, wherein first layer comprises a substrate.

30. The method of claim 27, wherein providing a first layer of a first crystalline material comprises:
providing a substrate; and
depositing a first layer of a first crystalline material on the substrate.

31. The method of claim 27, wherein the buffer layers are epitaxially deposited and the layer of the second crystalline material is epitaxially deposited over the plurality of sets of buffer layers.

32. The method of claim 27, further comprising, pausing deposition between deposition of a buffer layer of the first crystalline material and deposition of a buffer layer of the second crystalline material.

33. The method of claim 27, further comprising, annealing the first layer and at least one set of buffer layers after deposition of the at least one set.

34. The method of claim 33, wherein the first layer and the at least one set of buffer layers are annealed until at least 70% of the misfit strain is relaxed in the at least one set of buffer layers.

35. The method of claim 27, further comprising depositing a compositionally graded buffer structure before deposition of the second layer.

36. The method of claim 27, wherein each interface between a buffer layer of the third crystalline material and a buffer layer of the fourth crystalline material includes at most 5 atomic layers of intermixing.

37. The method of claim 27, wherein the buffer layers comprise exclusively elemental and or binary materials.
